(19) United States
(12) Patent Application Publication
(10) Pub. No.: US 2020/0293874 A1
(43) Pub. Date: Sep. 17, 2020

(54) MATCHING BASED INTENT UNDERSTANDING WITH TRANSFER LEARNING

(71) Applicant: Microsoft Technology Licensing, LLC, Redmond, WA (US)

(72) Inventors: Jianshu JI, Bothell, WA (US); Yeyun GONG, Beijing (CN); Nan DUAN, Beijing (CN); Yi-Cheng PAN, Kirkland, WA (US); Guihong CAO, Sammamish, WA (US)

(21) Appl. No.: 16/299,582

(22) Filed: Mar. 12, 2019

(51) Int. Cl. G06N 3/08; G06N 20/00; G06N 5/04

(52) U.S. Cl. CPC G06N 3/08; G06N 5/04; G06N 20/00

(57) ABSTRACT

Described herein is a mechanism to identify user intent in requests submitted to a system such as a digital assistant or question-answer systems. Embodiments utilize a match methodology instead of a classification methodology. Features derived from a subgraph retrieved from a knowledge base based on the request are concatenated with pretrained word embeddings for both the request and a candidate predicate. The concatenated inputs for both the request and predicate are encoded using two independent LSTM networks and then a matching score is calculated using a match LSTM network. The result is identified based on the matching scores for a plurality of candidate predicates. The pretrained word embeddings allow for knowledge transfer since pretrained word embeddings in one intent domain can apply to another intent domain without retraining.

### FIELD

This application relates generally to digital assistants and other dialog systems. More specifically, this application relates to improvements in intent detection for language understand models used in digital assistants and other dialog systems.

### BACKGROUND

Natural language understanding is one component of digital assistants, question-answer systems, and other dialog or digital systems. The goal is to understand the intent of the user and to fulfill that intent.

As digital assistants and other systems become more sophisticated, the number of things the user wants to accomplish has expanded. However, as the number of possible intents a user can express to a system increases, so does the complexity of providing a system that understands all the possible intents a user can express.

It is within this context that the present embodiments arise.

### BRIEF DESCRIPTION OF DRAWINGS

FIG. 1 illustrates an example architecture of a digital assistant system.

FIG. 2 illustrates an example architecture of a question answer system.

FIG. 3 illustrates an example architecture for training a language understanding model according to some aspects of the present disclosure.

FIG. 4 illustrates an example architecture for a language understanding model according to some aspects of the present disclosure.

FIG. 5 illustrates a representative architecture for a knowledge embedding aspect of a language understanding model according to some aspects of the present disclosure.

FIG. 6 illustrates a representative flow diagram for a word embedding aspect of a language understanding model according to some aspects of the present disclosure.

FIG. 7 illustrates a representative flow diagram for a word embedding aspect of a language understanding model according to some aspects of the present disclosure.

FIG. 8 illustrates a representative architecture for a sentence embedding aspect of a language understanding model according to some aspects of the present disclosure.

FIG. 9 illustrates a representative architecture for a matching layer of a language understanding model according to some aspects of the present disclosure.

FIG. 10 illustrates a representative architecture for implementing the systems and other aspects disclosed herein or for executing the methods disclosed herein.

### DETAILED DESCRIPTION

The description that follows includes illustrative systems, methods, user interfaces, techniques, instruction sequences, and computing machine program products that exemplify illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

### Overview

The following overview is provided to introduce a selection of concepts in a simplified form that are further described below in the Description. This overview is not intended to identify key features or essential features of the claimed subject matter, nor is it intended to be used to limit the scope of the claimed subject matter. Its sole purpose is to present some concepts in a simplified form as a prelude to the more detailed description that is presented later.

In recent years, users are increasingly relying on digital assistants and other conversational agents (e.g., chat bots) to access information and perform tasks. In order to accomplish the tasks and queries sent to a digital assistant and/or other conversational agent, the digital assistant and/or other conversational agent utilizes a language understanding model to help convert the input information into a semantic representation that can be used by the system. A machine learning model is often used to create the semantic representation from the user input.

The semantic representation of a natural language input can comprise one or more intents and one or more slots. As used herein, “intent” is the goal of the user. For example, the intent is a determination as to what the user wants from a particular input. The intent may also instruct the system how to act. A “slot” represents actionable content that exists within the input. For example, if the user input is “show me the trailer for Avatar,” the intent of the user is to retrieve and watch content. The slots would include “Avatar” which describes the content name and “trailer” which describes the content type. If the input was “order me a pizza,” the intent is to order/purchase something and the slots would include pizza, which is what the user desires to order. A slot is also referred to herein as an entity. Both terms mean the same thing and no distinction is intended. Thus, an entity represents actionable content that exists within the input request.

The intents/slots are often organized into domains, which represent the scenario or task the input belongs to at a high level, such as communication, weather, places, calendar, and so forth. Given the breadth of tasks that a user can desire to perform as the capability of digital assistants and other similar systems increase, there can be hundreds or thousands of domains.

There have traditionally been two approaches to developing robust intent and slot detection mechanisms. The first approach is to create linguistic rules that map input requests to the appropriate intent and/or slots. The linguistic rules typically are applied on a domain by domain basis. Thus, the system will first attempt to identify the domain and the evaluate the rules for that domain to map the input request to the corresponding intent/slot(s). The problem with rule-based approaches is that as the number of domains and intents grow, it quickly becomes impossible to create linguistic rules that handle all the variations that can exist for the different requests in all the different domains and/or intents.

To solve this problem, a second approach is sometimes taken where the mapping from input request to intent/slots is cast as a classification problem to which machine learning techniques can be applied. While machine learning classifiers can be effective for a certain number of domains and intents, as the number grows, a problem with obtaining or creating a sufficient amount of training data for all the different domains and intents quickly arises. Machine learning techniques are only effective if there exists a sufficient body of training data. When the number of domains and intents increases, it becomes increasingly difficult to sufficiently train the machine learning classifiers for all the different domains and intents. Thus, obtaining training data for the breadth of domains and intents can be a significant barrier to developing a robust intent and slot tagging mechanisms using machine learning classifiers.

Embodiments of the present disclosure utilize several mechanisms that help reduce or eliminate these problems. Embodiments of the present disclosure utilize a deep learning model that: 1) does not require complex linguistic rules; 2) utilizes a matching model instead of a classification model, which makes it possible to be domain-agnostic and thus only has one model for all different intents; and 3) leverages transfer learning and utilizes pretrained models as input features, which reduces or eliminates the need for separate training for different domains and/or intents. Thus, embodiments of the present disclosure address difficulties in designing complex rules and/or logic for a large number of intents. Additionally, embodiments of the present disclosure reduce efforts needed to acquire or develop large amounts of training data for all the different intents supported by a system.

Since embodiments of the present disclosure use a matching (rather than a classification) approach, a received request is compared to a plurality of candidate intent predicates and a matching score is calculated using machine learning methods. A selection criteria is used to select one of the candidate intent predicates as the intent associated with the input request. The intent predicate then drives further processing in the system and is used to fulfill the user's request.

Embodiments use a large corpus of pretrained word features to accomplish both knowledge transfer between domains and speed up calculation of the matching score. The word features in the corpus are matched against the words in received request and candidate predicates to identify a set of request word embeddings and a set of predicate word embeddings.

Embodiments of the present disclosure identify entities in an input request and use the identified entities to retrieve a subgraph from a knowledge base. A convolutional neural network is used to extract knowledge features from the subgraph. The knowledge features are concatenated with the request word embeddings and predicate word embeddings to yield a set of request inputs and a set of predicate inputs.

The request inputs are input into a first trained bi-directional Long Short Term (BiLSTM) neural network to accomplish sentence encoding for the request and the predicate inputs are input into a second trained BiLSTM neural network to accomplish sentence encoding for the predicate.

The outputs of the two BiLSTM sentence encoder neural networks are input into a match BiLSTM network so that a matching score can be calculated based on the encoded request and predicate. A selection criteria is used to select a predicate from among the candidate predicates based on the matching scores.

### Description

Embodiments of the present disclosure can apply to a wide variety of systems whenever user input is evaluated for a semantic information or converted to a semantic representation prior to further processing. Example systems in which embodiments of the present disclosure can apply include, but are not limited to, digital assistants and other conversational agents (e.g., chat bots), search systems, and any other system where a user input is evaluated for semantic information and/or converted to a semantic representation in order to accomplish the tasks desired by the user.

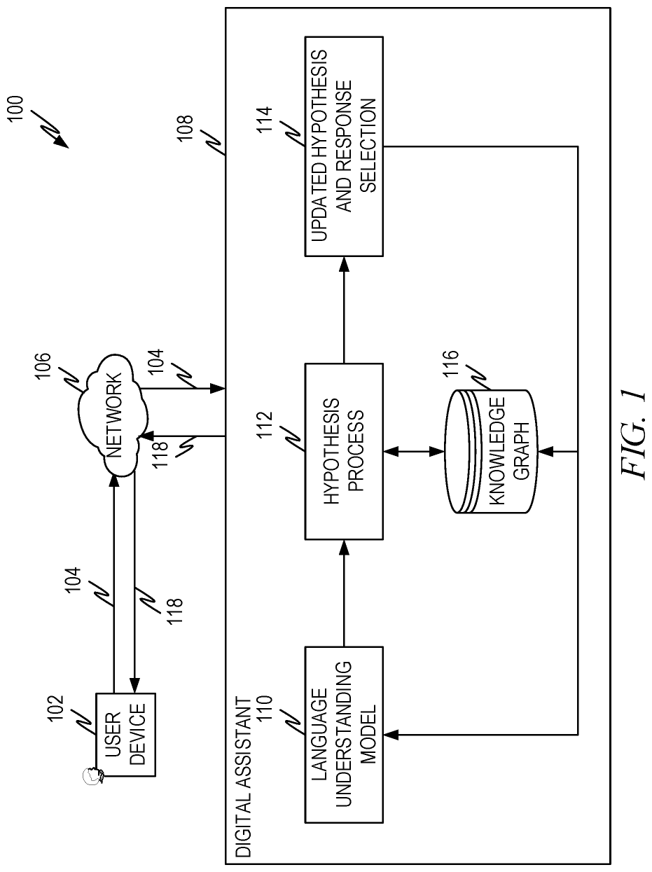

FIG. 1 illustrates an example architecture 100 of a digital assistant system. The present disclosure is not limited to digital assistant systems, but can be applied in any system that utilizes machine learning to convert user input into a semantic representation (e.g., intent(s) and/or slot(s)). However, the example of a digital assistant will be used in this description to avoid awkward repetition that the applied system could be any system evaluates user input for semantic information or converts user input into a semantic representation.

The simplified explanation of the operation of the digital assistant is not presented as a tutorial as to how digital assistants work, but is presented to show how the machine learning process that can be trained by the system(s) disclosed herein operate in a representative context. Thus, the explanation has been kept to a relatively simplified level in order to provide the desired context yet not devolve into the detailed operation of digital assistants.

A user may use a computing device 102 of some sort to provide input to and receive responses from a digital assistant system 108, typically over a network 106. Example computing devices 102 can include, but are not limited to, a mobile telephone, a smart phone, a tablet, a smart watch, a wearable device, a personal computer, a desktop computer, a laptop computer, a gaming device, a television, or any other device such as a home appliance or vehicle that can use or be adapted to use a digital assistant.

In some implementations, a digital assistant may be provided on the computing device 102. In other implementations, the digital assistant may be accessed over the network and be implemented on one or more networked systems as shown.

User input 104 may include, but is not limited to, text, voice, touch, force, sound, image, video and combinations thereof. This disclosure is primarily concerned with natural language processing and thus text and/or voice input is more common than the other forms, but the other forms of input can also utilized machine learning techniques disclosed herein.

User input 104 is transmitted over the network to the digital assistant 108. The digital assistant comprises a language understanding model 110, a hypothesis process 112, an updated hypothesis and response selection process 114, and a knowledge graph (also called a knowledge base) or other data source 116 that is used by the system to effectuate the user's intent.

The various components of the digital assistant 108 can reside on or otherwise be associated with one or more servers, cloud computing environments and so forth. Thus, the components of the digital assistant 108 can reside on a single server/environment or can be disbursed over several servers/environments. For example, the language understanding model 110, the hypothesis process 112 and the updated hypothesis and response selection process 114 can reside on one server or set of servers while the knowledge graph 116 can be hosted by another server or set of servers. Similarly, some or all the components can reside on user device 102.

User input 104 is received by the digital assistant 108 and is provide to the language understanding model 110. In some instances, the language understanding model 110 or another component converts the user input 104 into a common format such as text that is further processed. For example, if the input is in voice format, a speech to text converter can be used to convert the voice to text for further processing. Similarly, other forms of input can be converted or can be processed directly to create the desired semantic representation.

The language understanding model 110 converts the user input 104 into a semantic representation that includes at least one intent and at least one slot. As used herein, “intent” is the goal of the user. For example, the intent is a determination as to what the user wants from a particular input. The intent may also instruct the system how to act. A “slot” (sometimes referred to as an entity) represents actionable content that exists within the input. For example, if the user input is “show me the trailer for Avatar,” the intent of the user is to retrieve and watch content. The slots would include “Avatar” which describes the content name and “trailer” which describes the content type. If the input was “order me a pizza,” the intent is to order/purchase something and the slots would include pizza, which is what the user desires to order. The intents/slots are often organized into domains, which represent the scenario or task the input belongs to at a high level, such as communication, weather, places, calendar, and so forth. There can be hundreds or even thousands of domains which contain intents and/or slots and that represent scenario or task that a user may want to do.

In this disclosure, the term “domain” is used to describe a broad scenario or task that user input belongs to at a high level such as communication, weather, places, calendar and so forth.

The semantic representation with its intent(s) and slot(s) are used to generate one or more hypotheses that are processed by the hypothesis process 112 to identify one or more actions that may accomplish the user intent. The hypothesis process 112 utilizes the information in the knowledge graph 116 to arrive at these possible actions.

The possible actions are further evaluated by updated hypothesis and response selection process 114. This process 114 can update the state of the conversation between the user and the digital assistant 108 and make decisions as to whether further processing is necessary before a final action is selected to effectuate the intent of the user. If the final action cannot or is not yet ready to be selected, the system can loop back through the language understanding model 110 and/or hypothesis processor 112 to develop further information before the final action is selected.

Once a final action is selected, the response back to the user 118, either accomplishing the requested task or letting the user know the status of the requested task, is provided by the digital assistant 108.

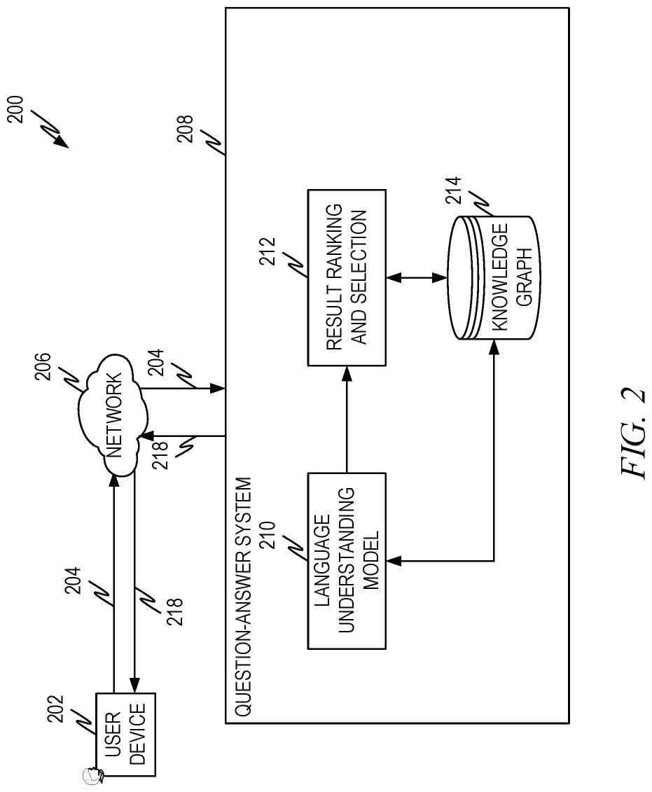

Another context where embodiments of the present disclosure can be utilized is in a question-answer system, such as the simplified architecture 200 of FIG. 2. Although the architecture 200 is shown as a stand-alone question-answer system, such question-answer systems are often part of search systems or other dialog systems.

The simplified explanation of the operation of the question-answer is not presented as a tutorial as to how question-answer systems work but is presented to show how the machine learning process that can be trained by the system(s) disclosed herein operate in a representative context. Thus, the explanation has been kept to a relatively simplified level in order to provide the desired context yet not devolve into the detailed operation of question-answer systems.

At a high-level question-answer systems convert a natural language query/question to an encoded form that can be used to extract facts from a knowledge graph (also referred to as a knowledge base) in order to answer questions.

A user may use a computing device 202 of some sort to provide input to and receive responses from the question-answer system 208, typically over a network 206. Example computing devices 202 can include, but are not limited to, a mobile telephone, a smart phone, a tablet, a smart watch, a wearable device, a personal computer, a desktop computer, a laptop computer, a gaming device, a television, or any other device such as a home appliance or vehicle that can use or be adapted to use a question-answer system.

In some implementations, a question-answer system may be provided on the computing device 202. In other implementations, the question-answer system may be accessed over the network and be implemented on one or more networked systems as shown.

User input 204 may include, but is not limited to, text, voice, touch, force, sound, image, video and combinations thereof. This disclosure is primarily concerned with natural language processing and thus text and/or voice input is more common than the other forms, but the other forms of input can also utilized machine learning techniques disclosed herein.

User input 204 is transmitted over the network to the question-answer system 208. The question-answer system comprises a language understanding model 210, a result ranking and selection process 212, and a knowledge graph (also called a knowledge base) or other data source 214 that is used by the system to effectuate the user's intent.

The various components of the question-answer system 208 can reside on or otherwise be associated with one or more servers, cloud computing environments and so forth. Thus, the components of the question-answer system 208 can reside on a single server/environment or can be disbursed over several servers/environments. For example, the language understanding model 210 and the result ranking and selection process 212 can reside on one server or set of servers while the knowledge graph 214 can be hosted by another server or set of servers. Similarly, some or all the components can reside on user device 202.

User input 204 is received by the question-answer system 208 and is provided to the language understanding model 210. In some instances, the language understanding model 210 or another component converts the user input 204 into a common format such as text that is further processed. For example, if the input is in voice format, a speech to text converter can be used to convert the voice to text for further processing. Similarly, other forms of input can be converted or can be processed directly to create the desired semantic representation.

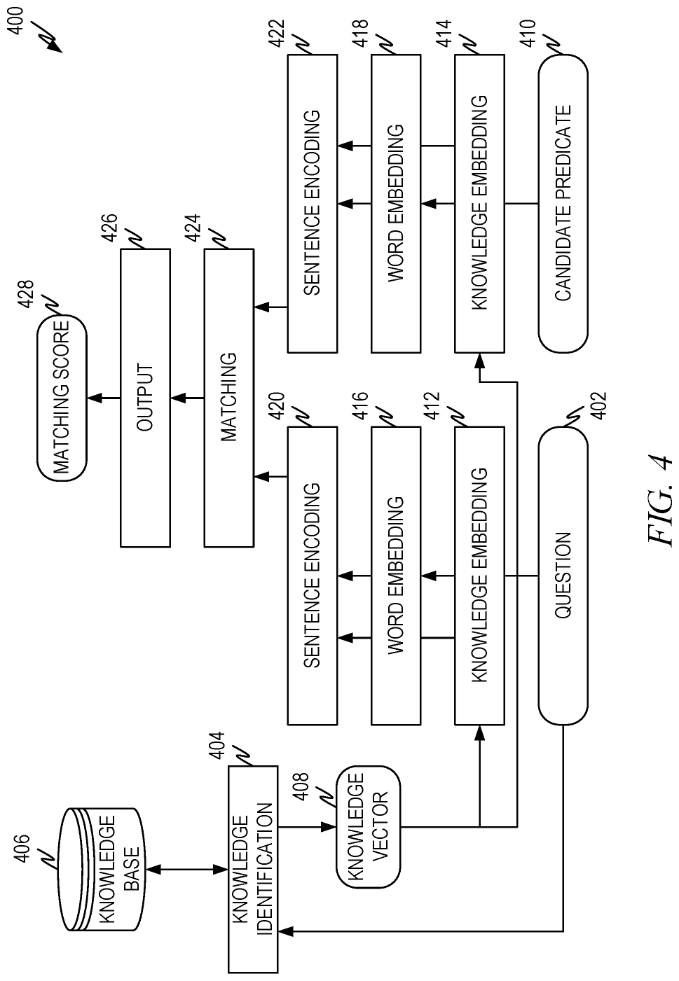

The language understanding model 210 converts the user input 204 into a candidate answer or series of candidate answers. As shown below in conjunction with FIG. 4, the language model encodes the question and a candidate predicate and generates a matching score for the candidate predicate. The result ranking and selection process 212 evaluates the scores for the candidate predicates and selects one or more to return to the user as answer(s) 118 to the submitted question.

Thus, the language model 210 of the question-answer system 208 differs from the language model 110 of the digital assistant 108 in that for the question-answer system 208, the candidate predicates are potential answers to the question while in the digital assistant 108, the candidate predicates are potential slot(s) and/or intent(s).

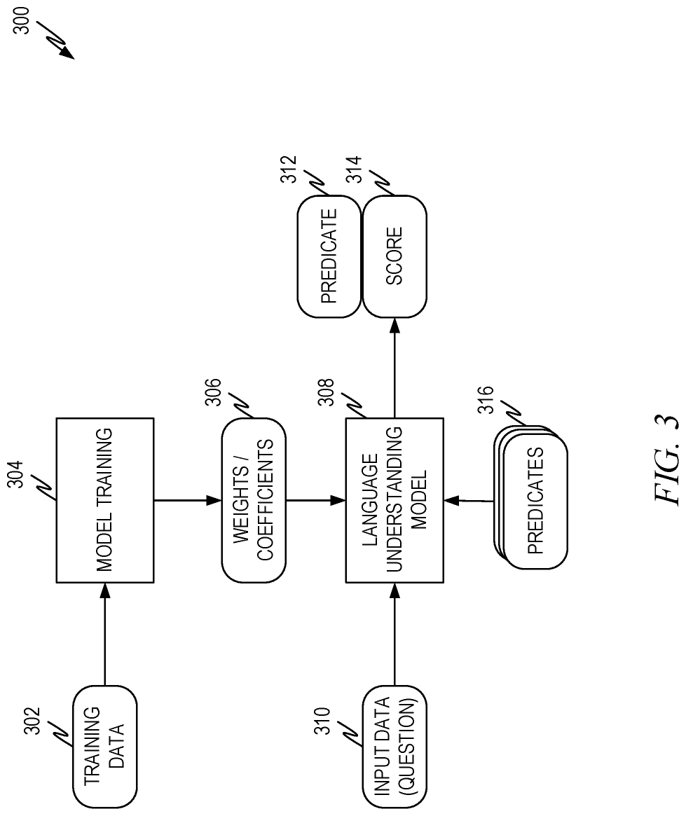

FIG. 3 illustrates an example architecture 300 for training a language understanding model according to some aspects of the present disclosure. Training data 302 is obtained in order to train the machine learning model. For the embodiments of the present disclosure, several machine learning models are used. Thus, training includes training of the different machine learning models. Additionally, embodiments of the disclosure utilize pretrained word embeddings, which are trained offline.

In the embodiment of FIG. 3, the training data 302 can comprise the synthetic and/or collected user data. The training data 302 is then used in a model training process 304 to produce weights and/or coefficients 306 that can be incorporated into the machine learning process incorporated into the language understanding model 308. Different machine learning processes will typically refer to the parameters that are trained using the model training process 304 as weights, coefficients and/or embeddings. The terms will be used interchangeably in this description and no specific difference is intended as both serve the same function which is to convert an untrained machine learning model to a trained machine learning model.

Once the language understanding model 308 has been trained (or more particularly the machine learning process utilized by the language understanding model 308), user input 310 that is received by the system and presented to the language understanding model 308 is compared against candidate predicates 316 and the result is a matching score 314 that is associated with a candidate predicate 312. The matching score 314 represents the likelihood that the predicate 312 “matches” the input question 310.

In the digital assistant context, the candidate predicates 316 comprise a plurality if intents and slots, which can be organized into domains as described herein. For example, the input phrase “reserve a table at joey's grill on Thursday at seven pm for five people” can have the sematic representation of:
Intent: Make Reservation
Slot: Restaurant: Joey's Grill
Slot: Date: Thursday
Slot: Time: 7:00 pm
Slot: Number People: 5

Furthermore, the Make Reservation intent can reside in a Places domain. The domain can be an explicit output of the language understanding model or can be implied by the intent(s) and/or slot(s).

In the question-answer system context, the candidate predicates 316 are potential answers to the input question 310. The score 314 indicates the likelihood that the associated predicate 312 is the answer to the input question 310. In other contexts, the candidate predicates 316 would be possible matches to the input query 310.

FIG. 4 illustrates an example architecture 400 for a language understanding model according to some aspects of the present disclosure. The architecture 400 solves the matching problem, that given a user request (often referred to in matching architectures as a question 402) and a set of candidate intent predicates P={p₁, p₂, . . . , pₘ}, the architecture selects the predicate that is most related to the user input question 402. More particularly, the architecture 400 receives as input a user input 402 and a candidate predicate 410 and produces a matching score 428. The matching score 428 indicates the relevance between the user input request 402 and the predicate 410. The matching scores for a set of candidate predicates can be calculated using the architecture and a selection mechanism used to select an intent based on the matching scores as described herein.

The architecture 400 comprises five layers: a Knowledge Embedding Layer; a Word Embedding Layer; a Sentence Encoding Layer; a Matching Layer; and an Output Layer. The layers are briefly summarized and then discussed in more detail below.

The knowledge embedding layer uses a knowledge identification process 404 to derive knowledge embedding features 408 from a subgraph of a knowledge base 406. The resultant knowledge embedding features 412, 414 are combined with word embeddings 416, 418 and presented to the sentence encoding layer 420, 422 for sentence encoding.

The outputs of the respective sentence encoding layers 420, 422 are input into the matching layer 424. The output of the matching layer 424 is input into the output layer 426 which produces the matching score 428 as discussed in greater detail below.

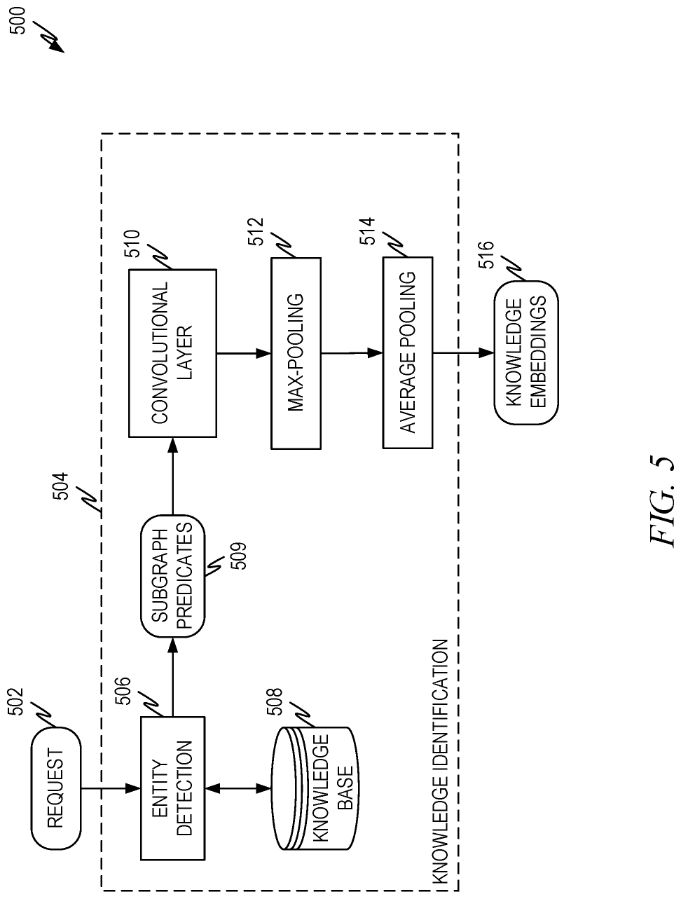

FIG. 5 illustrates a representative architecture 500 for a knowledge embedding aspect of a language understanding model according to some aspects of the present disclosure. For example, FIG. 5 represents an example implementation of knowledge embedding layer 412 and/or knowledge embedding layer 414.

The knowledge embeddings 516 are derived from a subgraph of a knowledge base 508. The knowledge base 508 is sometimes referred to as a knowledge index or knowledge graph is a directed graph. The knowledge base contains a collection of subject-predicate-object triples: {s, p, o}. Each triple in the knowledge base has two nodes, a subject entity s, and an object entity o, which are linked together by the predicate p. For example, one triple in a knowledge base may be {Tom Hanks, person.person.married, Rita Wilson} indicating that Tom Hanks is currently married to Rita Wilson. Another example may be {Christopher Nolan, film.film.director, Inception} indicating that Christopher Nolan directed the film Inception. An example knowledge base is Freebase, an online collaborative knowledge base containing more than 46 million topics and 2.6 billion facts. As of this writing, Freebase has been shuttered but the data can still be downloaded from www.freebase.com. Freebase has been succeeded in some sense by Wikidata, available at www.wikidata.org.

The architecture 500 illustrates a representative knowledge identification process 504 which receives an input user request 502 and produces knowledge embeddings 516 using the knowledge base 508. The process 504 identifies an entity from the input request 502 using an entity detection process 506. For example, if the request was “who is the director of Inception,” the entity detection process 506 would extract the entity “Inception.”

In a representative embodiment, a BiLSTM-Conditional Random Field (CRF) based entity linking method can be used to extract an entity from the input request and a subgraph from the knowledge base. One such approach is discussed in “SimpleQuestions Nearly Solved: A New Upperbound and Baseline Approach,” Michael Petrochuk and Luke Zettlemoyer, arXiv:1804.08798v1 [cs.CL] 24 Apr. 2018, which is incorporated herein in its entirety by reference. Such an approach uses a CRF tagger to determine the subject alias and a BiLSTM to classify the relationship (i.e., predicate).

Given a request, which will be referred to as a question q in this section for notation sake, (e.g., q=“who wrote gulliver's travels?”) the method 506 predicts the corresponding subject-predicate pair (s, p). The entity detection method 506 uses two learned distributions. The subject recognition model P(a I q) ranges over text spans A within the question q including the correct answer, which for the example above is “gulliver's travels.” This distribution is modeled with a CRF. The predicate model P (p|q, a) is used to select a knowledge base 508 predicate p that matches the question q. This distribution ranges over all relations in the knowledge base 508 that have an alias that matches a. This distribution is modeled with a BiLSTM that encodes q.

Given these two distributions, the final subject-predicate pair (s, p) is predicted as follows. The most likely subject prediction according to P(a|q) that also matches a subject alias in the knowledge base is found. Then all other knowledge base entities that share that alias are found and added to a set, S. P is then defined such that ∀(s, p)∈KB{p E PΛs∈S}, where KB{ } is the resultant subgraph 509 of knowledge base 508. Using a relation classification model P (p|q, a) the most likely relation pₘₐₓ∈P is predicted.

Embodiments can model the top-k subject recognition P(a|q) using a linear-chain CRF with conditional log likelihood loss objective. k candidates are inferred using the top-k Viterbi algorithm.

The model is trained with a dataset of question (i.e., input) tokens and their corresponding object alias spans using BIO (e.g., Begin, Intermediate, Other) tagging. The subject alias spans are determined by matching a phrase in the question with a knowledge base alias for the subject.

As for hyperparameters, in some embodiments, the model word embeddings are initialized with GloVe (i.e., Global Vectors for Word Representation, an unsupervised learning method for obtaining vector representations for words) and frozen. In some embodiments, the Adam optimization method for deep learning with a learning rate of 0.0001 is employed to optimize the model weights. The learning rate can be halved if the validation accuracy has not improved in three epochs. Hyperparameters can further be hand tuned and a limited set tuned with grid search to increase validation accuracy, if desired.

Embodiments can model the predicate classification P(p|q, a) with a one layer BiLSTM bachnorm softmax classifier that encodes the abstract predicate pₐ (e.g., “who wrote e”) as question q with an alias a abstracted. The model can be trained on a dataset of abstract predicates pₐ and predicate set P to ground truth predicate, p.

As for hyperparameters, in some embodiments, the model word embeddings are initialized with Fast-Text (described in “Enriching Word Vectors with Subword Information,” Piotr Bojanowski, Edouard Grave, Armand Joulin, Thomas Mikolov, arXiv:1607.04606 [cs.CL], 2016, incorporated herein by reference) and frozen. The AMSGrad variant of Adam initialized with a learning rate of 0.0001 can be employed to optimize the model weights. Finally, in some embodiments, the batch size can be doubled of the validation accuracy is not improved in three epochs. Hyperparameters can further be hand tuned and a limited set tuned with Hyperband (described in “Hyperband: A novel bandit-based approach to hyperparameter optimization,” Li, L & Jamieson, K & DeSalvo, Giulia & Rostamizadeh, A & Talwalkar, A., Journal of Machine Learning Research. 18. 1-52 (2018), incorporated herein by reference) to increase validation accuracy, if desired. If Hyperband is used, 30 epochs per model and a total of 1000 epochs can be used.

Using the entity detection method 506 just described, a subgraph 509 of the knowledge base 508 is extracted. The predicates connected with the entity are extracted from the subgraph. Thus, the predicate list is represented by P={p₁, p₂, . . . , pₘ}. Each predicate pᵢ is broken into relation names and words. For example, the predicate film.director.date_of_birth is split into a relation name {film.director.date_of_ birth} and words {film, director, date, of birth}. The domain (film in this example) is filtered to yield the remaining relationship name {director.date_of_ birth} and words {director, date, of birth}. Each token of the predicates is mapped to an embedding r.

Each predicate pᵢ is input into a Convolutional Neural Network (CNN) to encode it. The CNN comprises a convolutional layer 510 and a max-pooling layer 512. The convolutional layer 510 extracts local features, and the max-pooling layer 512 extracts global features.

In some embodiments, the convolutional layer 510 has a window size l and concatenates word embeddings in this window to yield a context vector, v. Thus, the method sets v[i:i+l]={vᵢ,vᵢ₊₁, . . . , vᵢ₊₁, . . . , vᵢ₊ₗ₋₁}. The method uses a kernel matrix W531 R^{l×d} and a non-linear function to operate on the contextual vector. The output of one operation is a local feature which can be computed as:

fᵢ=g(W·v[i:i+l]+b) (1)

Where g( ) is a non-linear function, such as ReLU, sigmoid, or tanh. The method conducts this operation on different contextual vectors, v_{i:l}, v_{2:l}, . . . , v_{n-l+1:n}, to get a set of local features f ={f₁, f₂, . . . , fₙ₋ₗ₊₁}. In some embodiments the ReLU function is used, while in other embodiments, a different non-linear function is used.

The max-pooling layer 512 extracts a maximum feature from the local features generated by one kernel. The method combines the outputs of a max-pooling layer 512 to get the embeddings for the predicate. Let r represent the embeddings of the predicate. The method uses an average pooling layer 514 to integrate all the predicate embeddings, and get the subgraph embedding 516 which is given by z=Σᵢ₌₀^{|m|}rᵢ. Where m is the number of predicates in the subgraph. The embedding, z, is replicated for each word in the question and predicate.

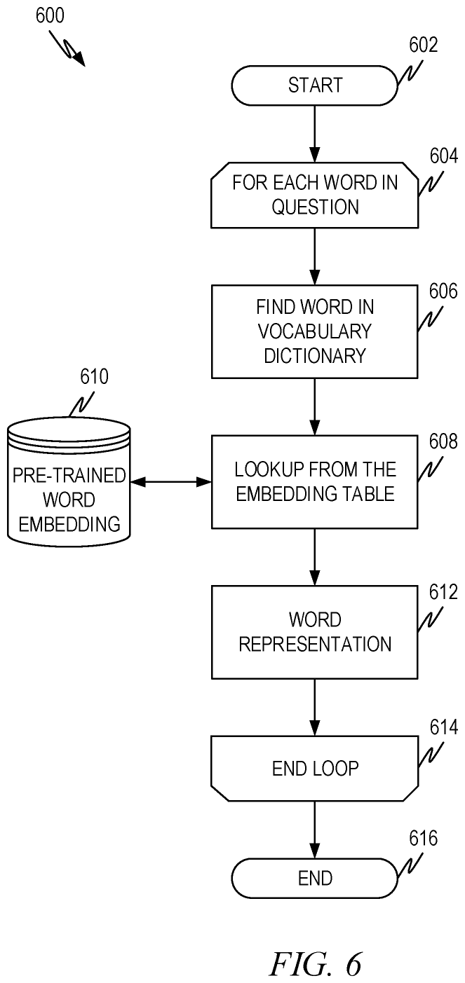

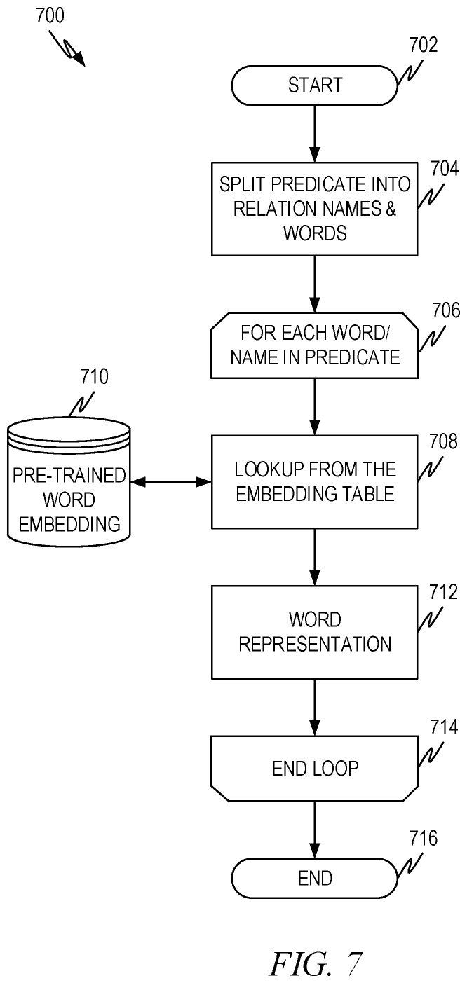

Returning for a moment to FIG. 4, the next layer in the architecture 400 is the word embedding layer 416 for the request and word embedding layer 418 for the candidate predicate 418. FIG. 6 describes a representative implementation for word embedding layer 418 and FIG. 7 describes a representative implementation for word embedding layer 418.

FIG. 6 illustrates a representative flow diagram 600 for a word embedding aspect of a language understanding model according to some aspects of the present disclosure. The flow diagram maps each word in the request, which will be referred to in the diagram for discussion purposes as the question, to a pre-trained word embedding. For the question, the flow diagram maps each word to a word ID based on a vocabulary dictionary and lookup from pre-trained word embeddings to generate a representation of each word.

The flow diagram begins at operation 602 and proceeds to operation 604 which begins a loop over all words in the question. Operation 606 considers the next word in the question and looks up the word in the vocabulary dictionary in order to find the word ID in the vocabulary. Operation 608 uses the word ID in the vocabulary and looks up the corresponding pre-trained word embeddings in a table or other store 610. Numerous pre-trained word embeddings exist and can be used, such as GloVe (available as of this writing from https://nlp.stanford.edu/projects/glove/), ELMo (available as of this writing from https://allennlp.org/elmo), fastText (available as of this writing from https://fasttext.cc), and others. In some embodiments, the pre-trained word embeddings from GloVe are used. In other embodiments, other pre-trained word embeddings can be used.

Operation 612 takes the word embedding from the lookup and adds it to the word embeddings as the word representation. Operation 614 closes the loop and the method ends at operation 616.

The resultant embeddings are represented herein as:

v^{q}={v₁^{q}, v₂^{q}, . . . , v_{|Q|}^{q}} (2)

Where v^{q} is the word embedding vector with its constituent members and |Q| is the number of words in the question.

FIG. 7 illustrates a representative flow diagram 700 for a word embedding aspect of a language understanding model according to some aspects of the present disclosure. The flow diagram maps each word in the candidate predicate, which will be referred to in the diagram for discussion purposes as the predicate, to a pre-trained word embedding. For the predicate, the flow diagram first splits the predicate into relation names and words, a set of tokens is obtained and lookup the word embeddings in a set of pre-trained embeddings based on the tokens.

The flow diagram begins at operation 702 and proceeds to operation 704 where the predicate is split into names and words. Using the same example as before, if the candidate predicate is film.director.date_of_birth, the predicate is split into a relation name {film, director, date_of_birth} and words {film, director, date, of birth}. The names and words are concatenated to yield {film, director, date_of_birth, film, director, date, of birth}.

Operation 706 begins a loop that loops over the names and words and retrieves the embeddings for each. Operation 708 obtains a token for the name or word under consideration and retrieves the embedding from a set of pre-trained word embeddings 710. These embeddings may be the same as those in FIG. 6 illustrated as 610.

Operation 712 takes the word embedding from the lookup and adds it to the word embeddings as the name/word representation. Operation 714 closes the loop and the method ends at operation 716.

The resultant embeddings are represented herein as:

v^{p}={v₁^{p}, v₂^{p}, . . . , v_{|P|}^{p}} (3)

Where v^{p} is the word embedding vector with its constituent members and |P| is the number of words and names in the predicate.

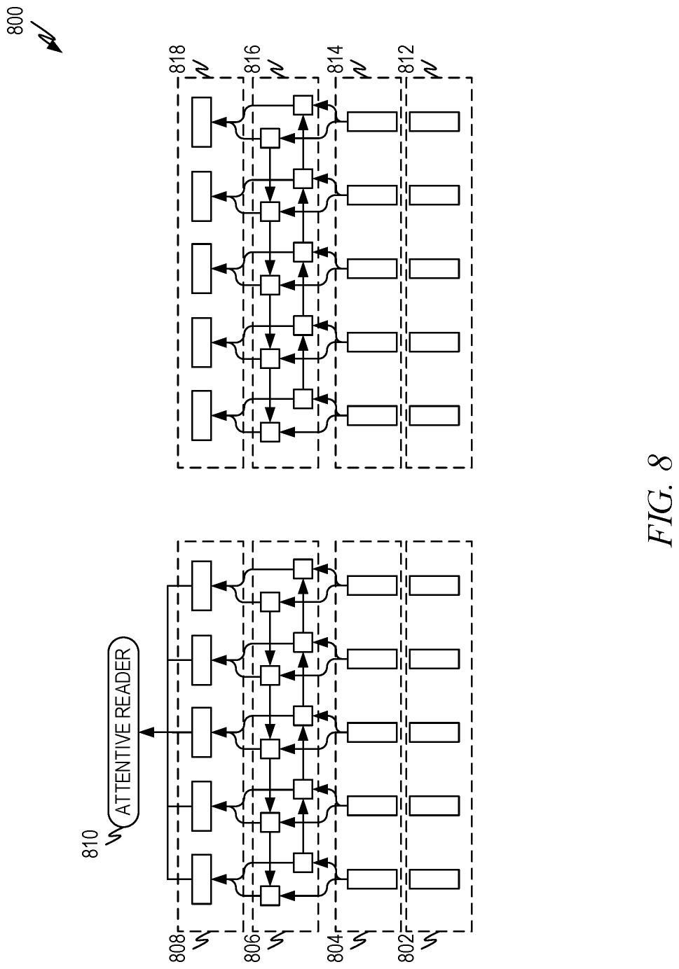

Returning for a moment to FIG. 4, the next layer in the architecture 400 is the sentence encoding layer 420 for the request 402 and sentence encoding layer 422 for the candidate predicate 418. The request and predicate are encoded separately as illustrated in FIG. 8.

FIG. 8 illustrates a representative architecture 800 for a sentence embedding aspect of a language understanding model according to some aspects of the present disclosure. The architecture 800 represents the request sentence encoding on the left (802, 804, 806, 808, 810) and the candidate predicate sentence encoding on the right (821, 814, 816, 818).

Discussing the request sentence encoding first, the input into the request encoding is created by concatenating the word embeddings for the request v^{q}={v₁^{q}, v₂^{q}, . . . , v_{|Q|}^{q}} illustrated by 804 with the knowledge embeddings, z, (516 of FIG. 5) and which is illustrated by 802. The concatenated input, x^{q}={[v₁^{q}; z], [v₂^{q}; z], . . . , [v_{|Q|}^{q}; z]}={w₁^{q}, w₂^{q}, . . . , w_{|Q|}^{q}}, is encoded by a BiLSTM 806 to generate the encoded hidden state h={h₁, h₂, . . . , h_{|Q|}} 808. A BiLSTM is well known and thus the following shorthand notation is used for BiLSTM 806 used in the architecture:

\vec{hₗ}=LSTM(h̅ᵢ̅₋̅₁̅, wᵢ^{q}) (4)

\vec{hₗ}=LSTM(\vec{hᵢ₊₁}, wᵢ^{q}) (5)

hᵢ=[\vec{hₗ}; \vec{hₗ}] (6)

The BiLSTM model parameters, typically represented by Wand b in common literature are co-trained as part of the whole model training with the final loss function and back propagation optimization algorithm as described herein.

In some embodiments, the output, h={h₁, h₂, . . . , h_{|Q|}} 808 is then input into an attentive reader layer 810, the output of which is input into the matching layer. The attentive reader layer can be any desired attentive reader layer, such as “regular” attention layer, a word-by-word attention layer, a two-way attention layer, and so forth. These are well known and need not be further discussed herein.

The sentence encoding for the predicate, mutatis mutandis, as described for the request encoding. The word embeddings for the predicate v^{p}={v₁^{p}, v₂^{p}, . . . , v_{|P|}^{p}}, given by equation (3) and illustrated in the figure as 814 above are concatenated with the knowledge embeddings, z 812, to provide the input, x^{p}={[v₁^{p}; z], [v₂^{p}; z], . . . ,[v_{|P|}^{p}; z]}={w₁^{p}, w₂^{p}, . . . , w_{|P|}^{p}}, is encoded by a BiLSTM 816 to generate the encoded hidden state k={k₁, k₂, . . . , k_{|P|}} 818. Thus:

\vec{kₗ}=LSTM(\vec{kₗ₋₁}, wᵢ^{p}) (4)

\vec{kₗ}=LSTM(\vec{kₗ₊₁}, wᵢ^{p}) (5)

kᵢ=[\vec{kₗ}; \vec{kₗ}] (6)

The BiLSTM model parameters, typically represented by Wand b in common literature are co-trained as part of the whole model training with the final loss function and back propagation optimization algorithm as described herein. In some embodiments, the predicate BiLSTM 816 can be trained separately from the request BiLSTM 806 so the trained neural network parameters are different for the two different BiLSTM neural networks.

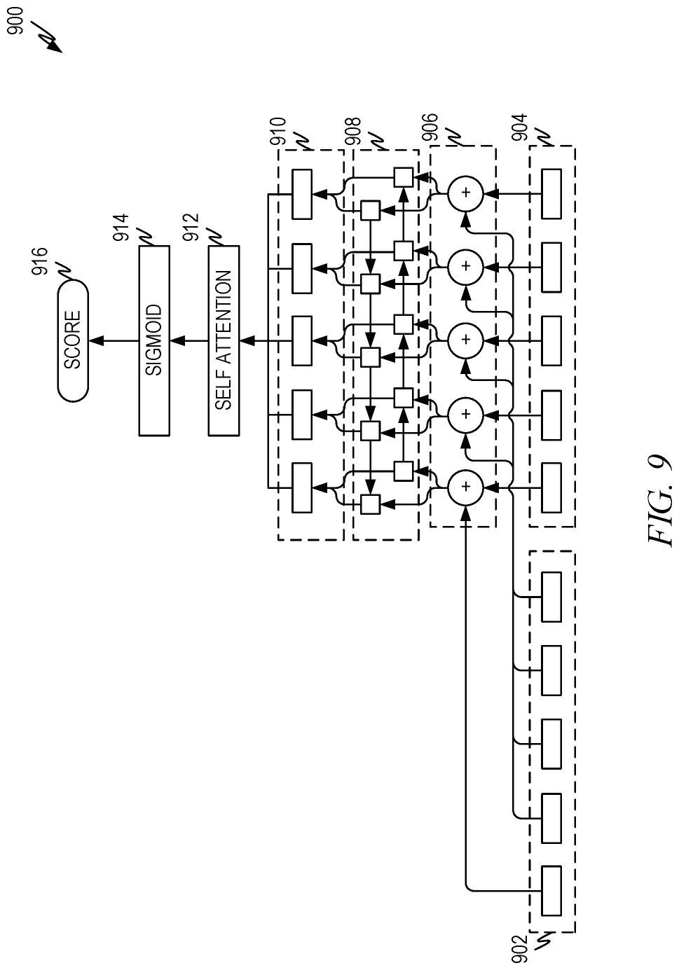

Returning for a moment to FIG. 4, the next layer in the architecture 400 is the matching layer 424. A representative embodiment for this layer is illustrated in FIG. 9.

FIG. 9 illustrates a representative architecture 900 for a matching layer of a language understanding model according to some aspects of the present disclosure. The architecture 900 utilizes a bi-directional match LSTM network 908 combined with other layers, as described. In the architecture 900, the input 902 is the output of the sentence encoding for the request and the input 904 is the output of the sentence encoding for the candidate predicate sentence encoding.

At each position, i, of the predicate tokens, the architecture first uses a word-by-word attention mechanism to obtain attention weights, a′, and compute a weighted sum of the predicate representation X. Thus:

$$\begin{matrix}{e}_{j}^{i} = {u}^{T} tanh ( {W}^{h} {h}_{j} + {W}^{k} {k}_{i} + {W}^{s} \vec{{s}_{l - 1}} + {b}_{e} ) & ( 7 ) \\ {a}_{j}^{i} = \frac{{e}_{j}^{i}}{{\sum }_{k = 1}^{\vert P \vert} {e}_{k}^{i}} & ( 8 ) \\ \vec{{c}_{l}} = {\sum }_{j = 1}^{\vert P \vert} {a}_{j}^{i} {h}_{j} & ( 9 )\end{matrix}$$

Where u, W, and bₑ are trainable parameters that are co-trained as part of the whole model training with the final loss function and back propagation optimization algorithm as described herein. \vec{cₗ}; is the attention-weighted version of the question for the i^{th} word in the predicate. It is concatenated with the current token of the predicate as:

\vec{rₗ}=[kᵢ; \vec{cₗ}] (10)

\vec{sₗ}=LSTM(\vec{rₗ}, \vec{sₗ₋₁}) (11)

Where \vec{sₗ} is the hidden state in the forward direction.

The architecture applies a similar match-LSTM in the reverse direction to compute the hidden state \vec{sₗ}. The two match-LSTM networks form the bi-directional match LSTM network 908. The final interaction represented by sᵢ is the concatenation of \vec{sₗ} and \vec{sₗ}. This is given by:

sᵢ=[\vec{sₗ}; \vec{sₗ}] (12)

The architecture 900 comprises an output layer, that in some embodiments comprises the self-attention layer 912 and sigmoid layer 914. The self-attention weight is computed by the bilinear dot product as:

$$\begin{matrix}{e}_{i}^{′} = {\sum }_{j = 0}^{\vert P \vert} {s}_{i}^{T} {W}^{b} {s}_{j} & ( 13 ) \\ {a}_{i}^{′} = \frac{{e}_{i}^{′}}{{\sum }_{j = 1}^{p} {e}_{j}^{′}} & ( 14 )\end{matrix}$$

Were W^{b} is a trainable parameter, trained according to known methods. The resulting self-attention weight a′ᵢ indicates the degree of matching between the i^{th} and j^{th} position of s. A weighted sum is computed as:

s_{f} =Σᵢ₌₀^{|P|}a′ᵢsᵢ (15)

Finally, a fully connected layer with a sigmoid activation function (i.e., sigmoid layer 914) computes the matching score between input request, q, and the candidate predicate, p using the logistic sigmoid function:

d=σ(W^{o}sₒ+b^{o}) (16)

Where σ(·) is the sigmoid function, and W^{o} and b^{o} are trainable parameters and d is the matching score 916.

To train the architecture, the following loss function is minimized on the training examples as:

[symbol]

=−y log(d)−(1−y)log(1−d) (17)

The trainable parameters are all co-trained as part of training the whole model training with the final loss function given by equation (17) and back a propagation optimization algorithm.

### Transfer Learning

One of the benefits of the present embodiments is the ability to use transfer learning so that the model can be, with appropriate design considerations, be domain-agnostic. This lowers or eliminates the training requirements between domains and improves the robustness and quality of the language understanding model because not only can more domains be handled by a trained language understanding model, the language understanding model is more robust and resilient to input requests that have not been seen before. Such benefits can be achieved through careful intent design and the use of pre-trained word embeddings.

Often, although domains are separate, they can be semantically similar. Consider the example of two requests:

1. “Who was the director of Inception?”

2. “Who was the director of Home Improvement?”

The requests reside in different domains as Inception is a movie and Home Improvement is a TV series. However, the requests are semantically similar in that both ask for a director. These two requests can have the same intent (knowledge of a director) but have two different slots (Inception in the first request and Home Improvement in the second request). By proper intent design, a language understanding model that is trained on the domain of Film can apply to the domain of TV with little or no additional training. The key is to recognize semantically similar intents and create candidate intent predicates based on semantic similarity between domains.

In accordance with the above, embodiments of the present disclosure can take advantage of semantic similarities between domains and reduce or eliminate the training requirements for additional domains. The domain-agnostic nature of the trained model has a lot of advantages over models that use classification for intent/slot identification. In a classification type system, additional intent domains cannot be added without additional training. Simply put, classification models will attempt to classify a new, never seen domain into an existing domain rather than identify it as a new domain. This is quite different than the way the disclosed embodiments work.

The second piece of the knowledge transfer ability of the embodiments of the present disclosure is using a large corpus of pre-trained word embeddings (e.g., 610, 710). The pre-trained word embeddings capitalize on the semantic similarity between intents that use semantically similar predicates between domains and allow for the training of domain agnostic language intent models. Thus, pre-trained word embeddings are domain agnostic and thus help extend the model's functioning to new domains that have not been specifically trained.

### Example Machine Architecture and Machine-Readable Medium

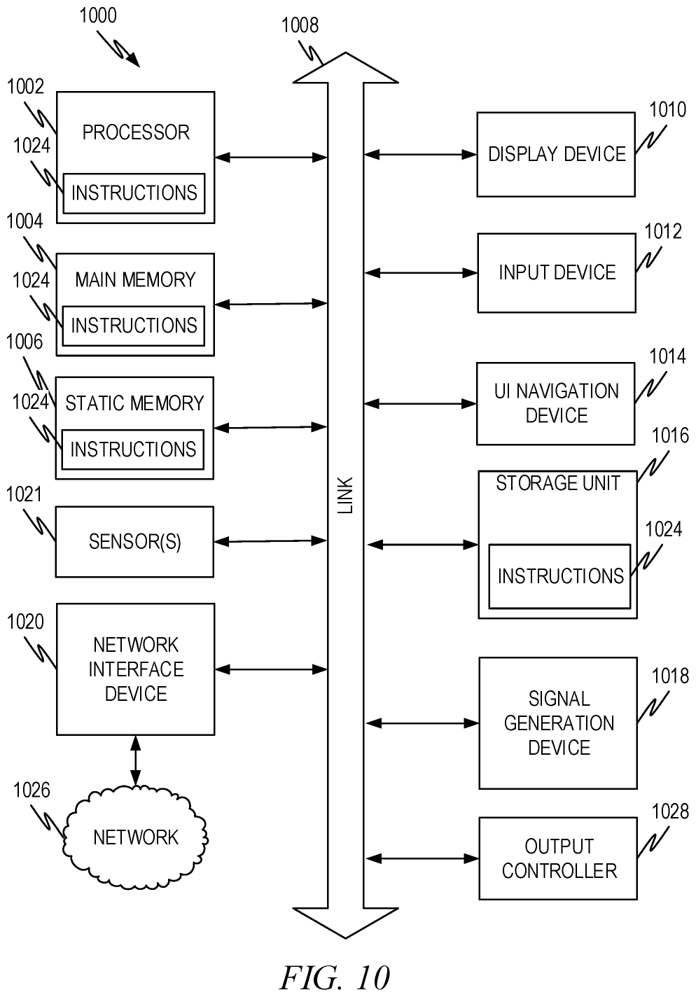

FIG. 10 illustrates a representative machine architecture suitable for implementing the systems and so forth or for executing the methods disclosed herein. The machine of FIG. 10 is shown as a standalone device, which is suitable for implementation of the concepts above. For the server aspects described above a plurality of such machines operating in a data center, part of a cloud architecture, and so forth can be used. In server aspects, not all of the illustrated functions and devices are utilized. For example, while a system, device, etc. that a user uses to interact with a server and/or the cloud architectures may have a screen, a touch screen input, etc., servers often do not have screens, touch screens, cameras and so forth and typically interact with users through connected systems that have appropriate input and output aspects. Therefore, the architecture below should be taken as encompassing multiple types of devices and machines and various aspects may or may not exist in any particular device or machine depending on its form factor and purpose (for example, servers rarely have cameras, while wearables rarely comprise magnetic disks). However, the example explanation of FIG. 10 is suitable to allow those of skill in the art to determine how to implement the embodiments previously described with an appropriate combination of hardware and software, with appropriate modification to the illustrated embodiment to the particular device, machine, etc. used.

While only a single machine is illustrated, the term “machine” shall also be taken to include any collection of machines that individually or jointly execute a set (or multiple sets) of instructions to perform any one or more of the methodologies discussed herein.

The example of the machine 1000 includes at least one processor 1002 (e.g., a central processing unit (CPU), a graphics processing unit (GPU), advanced processing unit (APU), or combinations thereof), one or more memories such as a main memory 1004, a static memory 1006, or other types of memory, which communicate with each other via link 1008. Link 1008 may be a bus or other type of connection channel. The machine 1000 may include further optional aspects such as a graphics display unit 1010 comprising any type of display. The machine 1000 may also include other optional aspects such as an alphanumeric input device 1012 (e.g., a keyboard, touch screen, and so forth), a user interface (UI) navigation device 1014 (e.g., a mouse, trackball, touch device, and so forth), a storage unit 1016 (e.g., disk drive or other storage device(s)), a signal generation device 1018 (e.g., a speaker), sensor(s) 1021 (e.g., global positioning sensor, accelerometer(s), microphone(s), camera(s), and so forth), output controller 1028 (e.g., wired or wireless connection to connect and/or communicate with one or more other devices such as a universal serial bus (USB), near field communication (NFC), infrared (IR), serial/parallel bus, etc.), and a network interface device 1020 (e.g., wired and/or wireless) to connect to and/or communicate over one or more networks 1026.

Executable Instructions and Machine-Storage Medium

The various memories (i.e., 1004, 1006, and/or memory of the processor(s) 1002) and/or storage unit 1016 may store one or more sets of instructions and data structures (e.g., software) 1024 embodying or utilized by any one or more of the methodologies or functions described herein. These instructions, when executed by processor(s) 1002 cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include storage devices such as solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage media, computer-storage media, and device-storage media specifically and unequivocally excludes carrier waves, modulated data signals, and other such transitory media, at least some of which are covered under the term “signal medium” discussed below.

### Signal Medium

The term “signal medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

### EXAMPLE EMBODIMENTS

Example 1. A method for detecting user intent in natural language requests, comprising:

receiving a request from a user;

identifying a candidate predicate based on the request;

retrieving a subgraph from a knowledge base based on the request;

concatenating features derived from the subgraph with pretrained word embeddings to yield a set of request inputs and a set of predicate inputs;

calculating a matching score for the request and candidate predicate using a trained machine learning model based on the set of request inputs and the set of predicate inputs;

selecting a matching predicate comprising user intent based on the matching score.

Example 2. The method of example 1 wherein the trained machine learning model comprises a first trained bi-directional LSTM neural network and a second trained bi-directional LSTM network.

Example 3. The method of example 1 wherein the trained machine learning model comprises a trained bi-directional matching LSTM neural network.

Example 4. The method of example 3 wherein the trained machine learning model further comprises a first trained bi-directional LSTM network utilizing the set of request inputs and a second trained bi-directional LSTM network utilizing the set of predicate inputs.

Example 5. The method of example 1 wherein the set of request inputs comprises word embedding based on the request concatenated with a subset of the features derived from the subgraph.

Example 6. The method of example 1 wherein the set of predicate inputs comprises word embedding based on the candidate predicate concatenated with a subset of the features derived from the subgraph.

Example 7. The method of example 1 wherein the trained machine learning model comprises a self-attention layer.

Example 8. The method of example 1 wherein the trained machine learning model comprises a sigmoid layer.

Example 9. The method of example 1 wherein the pretrained word embeddings for a first intent domain also apply to a second intent domain without retraining.

Example 10. The method of example 1 wherein retrieving a subgraph from a knowledge base based on the request comprises:

detecting an entity in the request;

retrieving the subgraph from the knowledge base based on the entity;

deriving the features from the subgraph using a convolutional neural network.

Example 11. A system comprising a processor and computer executable instructions, that when executed by the processor, cause the system to perform operations comprising:

receive a request from a user;

identify a candidate predicate based on the request;

retrieve a subgraph from a knowledge base based on the request;

deriving a set of features from the subgraph using a convolutional neural network;

concatenate features from the set of features with pretrained word embeddings to yield a set of request inputs and a set of predicate inputs;

calculate a matching score for the request and candidate predicate using a trained machine learning model based on the set of request inputs and the set of predicate inputs;

select a matching predicate comprising user intent based on the matching score.

Example 12. The system of example 11 wherein the trained machine learning model comprises a first trained bi-directional LSTM neural network and a second trained bi-directional LS TM network.

Example 13. The system of example 11 wherein the trained machine learning model comprises a trained bi-directional matching LSTM neural network.

Example 14. The system of example 13 wherein the trained machine learning model further comprises a first trained bi-directional LSTM network utilizing the set of request inputs and a second trained bi-directional LSTM network utilizing the set of predicate inputs.

Example 15. The system of example 11 wherein the set of request inputs comprises word embedding based on the request concatenated with a subset of the features derived from the subgraph.

Example 16. A method for detecting user intent in natural language requests, comprising:

receiving a request from a user;

identifying a candidate predicate based on the request;

retrieving a subgraph from a knowledge base based on the request;

concatenating features derived from the subgraph with pretrained word embeddings to yield a set of request inputs and a set of predicate inputs;

calculating a matching score for the request and candidate predicate using a trained machine learning model based on the set of request inputs and the set of predicate inputs;

selecting a matching predicate comprising user intent based on the matching score.

Example 17. The method of example 16 wherein the trained machine learning model comprises a first trained bi-directional LSTM neural network and a second trained bi-directional LSTM network.

Example 18. The method of example 16 wherein the trained machine learning model comprises a trained bi-directional matching LSTM neural network.

Example 19. The method of example 18 wherein the trained machine learning model further comprises a first trained bi-directional LSTM network utilizing the set of request inputs and a second trained bi-directional LSTM network utilizing the set of predicate inputs.

Example 20. The method of example 16, 17, 18, or 19 wherein the set of request inputs comprises word embedding based on the request concatenated with a subset of the features derived from the subgraph.

Example 21. The method of example 16, 17, 18, 19, or 20 wherein the set of predicate inputs comprises word embedding based on the candidate predicate concatenated with a subset of the features derived from the subgraph.

Example 22. The method of example 16, 17, 18, 19, 20, or 21 wherein the trained machine learning model comprises a self-attention layer.

Example 23. The method of example 16, 17, 18, 19, 20, 21, or 22 wherein the trained machine learning model comprises a sigmoid layer.

Example 24. The method of example 16, 17, 18, 19, 20, 21, 22, or 23 wherein the pretrained word embeddings for a first intent domain also apply to a second intent domain without retraining.

Example 25. The method of example 16, 17, 18, 19, 20, 21, 22, 23, or 24 wherein retrieving a subgraph from a knowledge base based on the request comprises:

detecting an entity in the request;

retrieving the subgraph from the knowledge base based on the entity;

deriving the features from the subgraph using a convolutional neural network.

Example 26. The method of example 16, 17, 18, 19, 20, 21, 22, 23, 24, or 25 further comprising:

identifying a plurality of candidate predicates;

calculating matching scores for the plurality of candidate predicates;

selecting one or more matching predicates based the matching scores and the matching score.

Example 27. The method of example 26 wherein the candidate predicate and the plurality of candidate predicates comprise intents, slots, or both.

Example 28. The method of example 26 wherein the candidate predicate and the plurality of candidate predicates comprise potential answers to the request.

Example 29. An apparatus comprising means to perform a method as in any preceding example.

Example 30. Machine-readable storage including machine-readable instructions, when executed, to implement a method or realize an apparatus as in any preceding example.

### CONCLUSION

In view of the many possible embodiments to which the principles of the present invention and the forgoing examples may be applied, it should be recognized that the examples described herein are meant to be illustrative only and should not be taken as limiting the scope of the present invention. Therefore, the invention as described herein contemplates all such embodiments as may come within the scope of the following claims and any equivalents thereto.

What is claimed is:

1. A method for detecting user intent in natural language requests, comprising:
receiving a request from a user;
identifying a candidate predicate based on the request;
retrieving a subgraph from a knowledge base based on the request;
concatenating features derived from the subgraph with pretrained word embeddings to yield a set of request inputs and a set of predicate inputs;
calculating a matching score for the request and candidate predicate using a trained machine learning model based on the set of request inputs and the set of predicate inputs;
selecting a matching predicate comprising user intent based on the matching score.

2. The method of claim 1 wherein the trained machine learning model comprises a first trained bi-directional LSTM neural network and a second trained bi-directional LSTM network.

3. The method of claim 1 wherein the trained machine learning model comprises a trained bi-directional matching LSTM neural network.

4. The method of claim 3 wherein the trained machine learning model further comprises a first trained bi-directional LSTM network utilizing the set of request inputs and a second trained bi-directional LSTM network utilizing the set of predicate inputs.

5. The method of claim 1 wherein the set of request inputs comprises word embedding based on the request concatenated with a subset of the features derived from the subgraph.

6. The method of claim 1 wherein the set of predicate inputs comprises word embedding based on the candidate predicate concatenated with a subset of the features derived from the subgraph.

7. The method of claim 1 wherein the trained machine learning model comprises a self-attention layer.

8. The method of claim 1 wherein the trained machine learning model comprises a sigmoid layer.

9. The method of claim 1 wherein the pretrained word embeddings for a first intent domain also apply to a second intent domain without retraining.

10. The method of claim 1 wherein retrieving a subgraph from a knowledge base based on the request comprises:
detecting an entity in the request;
retrieving the subgraph from the knowledge base based on the entity;
deriving the features from the subgraph using a convolutional neural network.

11. A system comprising a processor and computer executable instructions, that when executed by the processor, cause the system to perform operations comprising:
receive a request from a user;
identify a candidate predicate based on the request;
retrieve a subgraph from a knowledge base based on the request;
deriving a set of features from the subgraph using a convolutional neural network;
concatenate features from the set of features with pretrained word embeddings to yield a set of request inputs and a set of predicate inputs;
calculate a matching score for the request and candidate predicate using a trained machine learning model based on the set of request inputs and the set of predicate inputs;
select a matching predicate comprising user intent based on the matching score.

12. The system of claim 11 wherein the trained machine learning model comprises a first trained bi-directional LSTM neural network and a second trained bi-directional LSTM network.

13. The system of claim 11 wherein the trained machine learning model comprises a trained bi-directional matching LSTM neural network.

14. The system of claim 13 wherein the trained machine learning model further comprises a first trained bi-directional LSTM network utilizing the set of request inputs and a second trained bi-directional LSTM network utilizing the set of predicate inputs.

15. The system of claim 11 wherein the set of request inputs comprises word embedding based on the request concatenated with a subset of the features derived from the subgraph.

16. The system of claim 11 wherein the set of predicate inputs comprises word embedding based on the candidate predicate concatenated with a subset of the features derived from the subgraph.

17. The system of claim 11 wherein the trained machine learning model comprises a self-attention layer.

18. The system of claim 11 wherein the trained machine learning model comprises a sigmoid layer.

19. The system of claim 11 wherein the pretrained word embeddings for a first intent domain also apply to a second intent domain without retraining.

20. A computer storage medium comprising executable instructions that, when executed by a processor of a machine, cause the machine to perform operations comprising:
receive a request from a user;
identify a candidate predicate based on the request;
identifying an entity in the request;
retrieve a subgraph from a knowledge base based on the entity;
deriving a set of features from the subgraph using a convolutional neural network;
concatenate features from the set of features with pretrained word embeddings to yield a set of request inputs and a set of predicate inputs;
calculate a matching score for the request and candidate predicate using a trained machine learning model based on the set of request inputs and the set of predicate inputs;
select a matching predicate comprising user intent based on the matching score.
